(19) United States
(12) Patent Application Publication
(10) Pub. No.: US 2014/0285501 A1
(43) Pub. Date: Sep. 25, 2014

(54) METHOD AND APPARATUS FOR CONTROLLING FRAGMENT IN GRAPHIC RENDERING

(71) Applicant: SAMSUNG ELECTRONICS CO., LTD., Suwon-si (KR)

(72) Inventors: Seok Yoon JUNG, Seoul (KR); Kwon Taek KWON, Seoul (KR); Sang Oak WOO, Anyang-si (KR)

(73) Assignee: SAMSUNG ELECTRONICS CO., LTD., Suwon-s (KR)

(21) Appl. No.: 14/135,883

(22) Filed: Dec. 20, 2013

(30) Foreign Application Priority Data
Mar. 25, 2013 (KR) 10-2013-0031323

(51) Int. Cl. G06T 15/00

(52) U.S. Cl. CPC G06T 15/005
USPC 345/520

(57) ABSTRACT

A method and apparatus for controlling a fragment that controls processing of a fragment during a graphic rendering process. The method of controlling the fragment includes determining whether to process a second fragment, based on flag data representing a processing state of a first fragment, and updating the flag data based on a processing state of at least one of the first fragment and the second fragment, wherein the first fragment and the second fragment refer to fragments representing an identical spatial location among fragments included in differing primitives in a frame.

### CROSS-REFERENCE TO RELATED APPLICATIONS

This application claims the priority benefit of Korean Patent Application No. 10-2013-0031323, filed on Mar. 25, 2013, in the Korean Intellectual Property Office, the disclosure of which is incorporated herein by reference.

### BACKGROUND

1. Field

Example embodiments of the following disclosure relate to a method and apparatus for controlling a fragment, and more particularly, a method and apparatus that controls processing of a fragment in a graphic rendering process using flag data.

2. Description of the Related Art

A three-dimensional (3D) graphic rendering apparatus may be built in various multimedia devices, and used for displaying a variety of graphics data, for example, a user interface (UI), 3D games, and 3D films. The 3D graphic rendering apparatus may include a graphics processing unit (GPU) for rapid processing of a rendering operation.

3D data inputted to the GPU may be provided by an application programming interface (API), for example, an open graphics library (OpenGL), and a Direct3D, and have a sequential data format. In particular, the 3D data to be processed by the GPU may be processed sequentially in the order in which the 3D data was inputted. Accordingly, an erroneous resulting image may be generated when the 3D graphic rendering apparatus that performs sequential processing of 3D data simultaneously processes 3D data occupying the same space in a predetermined processing step.

In the OpenGL, a fragment generated by a rasterizer may be processed sequentially in the order in which the fragment is provided to a fragment shader (FS). However, for swifter processing, general graphic rendering apparatuses may process a fragment through dispersing the fragment to a plurality of processors, or process the fragment in a sequential manner differing from a sequential manner in which the fragment is provided. In such a case, the 3D data occupying the same space may be reconfigured in a predetermined step, thereby requiring a process of being restored to an original sequential manner of input.

Accordingly, in view of the foregoing, there is a need for improved controlling of a fragment in graphic rendering.

### SUMMARY

The foregoing and/or other aspects are achieved by providing a method of controlling a fragment, the method including determining whether to process a second fragment based on flag data representing a processing state of a first fragment, and updating the flag data based on a processing state of at least one of the first fragment and the second fragment, wherein the first fragment and the second fragment correspond to fragments representing an identical spatial location from among fragments included in differing primitives in a frame.

The determining may include identifying a spatial location of the second fragment from location information of the second fragment, and determining whether to process the second fragment based on flag data corresponding to the spatial location of the second fragment.

The foregoing and/or other aspects are achieved by providing a method of controlling a fragment, the method including identifying flag data corresponding to a second fragment inputted subsequent to a first fragment in order to process, in a sequential manner, fragments having an identical spatial location in differing image frames, and determining whether to process the second fragment based on the flag data.

The method of controlling the fragment may further include updating the flag data when processing of at least one of the first fragment and the second fragment commences or is completed.

The foregoing and/or other aspects are achieved by providing an apparatus for controlling a fragment, the apparatus including a fragment control unit to determine whether to process a second fragment, based on flag data representing a processing state of a first fragment, and a flag data update unit to update the flag data, based on a processing state of the second fragment, wherein the first fragment and the second fragment correspond to fragments representing an identical spatial location among fragments included in differing primitives in a frame.

The apparatus for controlling a fragment may further include a fragment storage to store the second fragment until the flag data is updated during processing of the first fragment.

The foregoing and/or other aspects are also achieved by providing an apparatus for controlling a fragment, the apparatus including a flag data identification unit to identify flag data corresponding to a second fragment inputted subsequent to a first fragment in order to process, in a sequential manner, fragments having an identical spatial location in differing image frames, and a fragment control unit to determine whether to process the second fragment based on the flag data.

The apparatus for controlling a fragment may further include a flag data update unit to update flag data when processing of at least one of the first fragment and the second fragment commences or is completed.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 is a block diagram illustrating an overall configuration of a system for processing a fragment, according to example embodiments;

FIG. 2 is a block diagram illustrating a detailed configuration of an apparatus for controlling a fragment, according to example embodiments;

FIG. 3 is a block diagram illustrating a detailed configuration of an apparatus for controlling a fragment, according to other example embodiments;

FIG. 4 is a block diagram illustrating a detailed operation performed by an apparatus for controlling a fragment, according to example embodiments;

FIG. 5 illustrates an example of a flag buffer in which flag data is stored, according to example embodiments;

FIG. 6 is a flowchart illustrating an operation of a method of controlling a fragment, according to example embodiments; and

FIG. 7 is a flowchart illustrating an operation of a method of controlling a fragment, according to other example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

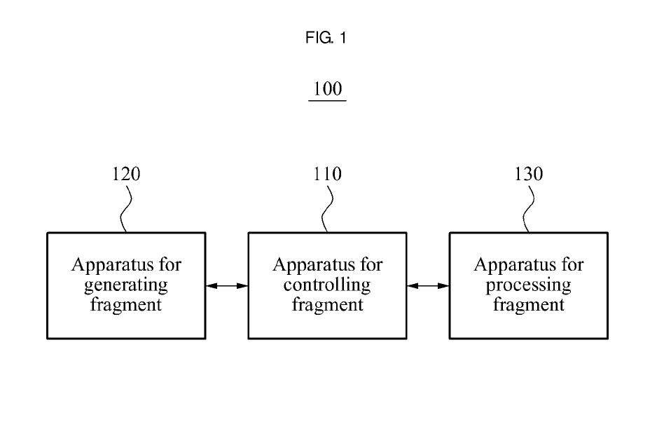

FIG. 1 is a block diagram illustrating an overall configuration of a system 100 for processing a fragment, according to example embodiments.

Referring to FIG. 1, the system 100 for processing the fragment may include an apparatus 120 for generating a fragment, an apparatus 110 for controlling a fragment, and an apparatus 130 for processing a fragment. Each of the above-described apparatuses may include at least one processing device.

The apparatus 120 for generating the fragment may generate a fragment, based on graphics data including three-dimensional (3D) information in a graphic rendering process. For example, the apparatus 120 for generating the fragment may include a rasterizer for generating a fragment, based on vertex data. In this example, the apparatus 120 for generating the fragment may transmit the generated fragment to the apparatus 110 for controlling the fragment. The description of the apparatus 120 for generating the fragment discussed above is exemplary, and thus, the present disclosure is not limited thereto.

A fragment may correspond to a pixel and include information associated with the pixel. For example, the fragment may include color information of a pixel, or location information of the pixel, such as a pixel coordinate (x, y) in an image frame, a depth value (z) of a pixel, and a texture coordinate (u, v). The description of the fragment discussed above is exemplary, and thus, the present disclosure is not limited thereto.

The apparatus 130 for processing the fragment may perform varied forms of graphics processing through receiving a fragment from the apparatus 110 for controlling the fragment. For example, the apparatus 130 for processing the fragment may include a fragment shader (FS) for applying a variety of effects to a fragment through performing a code implemented by a programmer. The apparatus 130 for processing the fragment discussed above is exemplary, and thus, the present disclosure is not limited thereto.

The apparatus 130 for processing the fragment may be configured by a single-core, or a multi-core to process fragments through dispersing the fragments. The apparatus 130 for processing the fragment configured by the single-core may adaptively adjust a processing sequence of the fragments to be inputted sequentially in order to enhance a processibility.

The apparatus 110 for controlling the fragment may control the processing of a fragment between the apparatus 120 for generating the fragment and the apparatus 130 for processing the fragment. The apparatus 110 for controlling the fragment may remove an error that may occur during processing of fragments through dispersing the fragments, or adaptively adjusting a processing order of the fragments to be inputted sequentially. In more detail, the apparatus 110 for controlling the fragment may prevent an erroneous image from being outputted due to a reversal of the processing order of fragments belonging to differing primitives present in an identical frame, despite occupying the same space.

For example, an output image may change when a blending order of fragments occupying the same space is reversed because a fragment represented as transparent and a fragment represented as opaque may exist on a screen. The apparatus 110 for controlling the fragment may control the processing order of the fragment, such that an order in which a fragment is displayed on a screen coincides with an order of a fragment to be inputted to the apparatus 130 for processing the fragment, thereby preventing an erroneous resulting image from being generated.

The apparatus 110 for controlling the fragment may use flag data to maintain the processing order of the fragments representing an identical spatial location among fragments included in differing primitives in a frame. More particularly, the apparatus 110 for controlling the fragment may control processing of a fragment received from the apparatus 120 for generating the fragment, based on the flag data representing a processing state of a fragment. The apparatus 110 for controlling the fragment may generate the flag data representing the processing state of the fragment through monitoring the apparatus 130 for processing the fragment.

For example, the apparatus 110 for controlling the fragment may control the apparatus 130 for processing the fragment to process fragments displayed at an identical location on a screen, in a sequential manner. To this end, the apparatus 110 for controlling the fragment may represent whether a fragment inputted earlier is being processed, and when a fragment having an identical spatial location is inputted later, may determine whether to process the fragment inputted later based on the flag data.

Hereinafter, a fragment inputted earlier to the apparatus 110 for controlling the fragment from the apparatus 130 for generating the fragment may be referred to as a “first fragment”, and a fragment inputted later than the first fragment may by referred to as a “second fragment” for ease of description. The first fragment and the second fragment may have an identical spatial location while belonging to differing primitives present in the same frame. Accordingly, the first fragment and the second fragment may be displayed at the identical location on a screen, and occupy the same space in a resulting image.

The apparatus 110 for controlling the fragment may determine whether the apparatus 130 for processing the fragment has completed processing of the first fragment through or by referring to flag data. The apparatus 110 for controlling the fragment may delay processing of the second fragment, or in another embodiment, momentarily store the second fragment in a buffer when the flag data represents that the first fragment is currently being processed by the apparatus 130 for processing the fragment. Subsequently, when the flag data is updated and represents that the processing of the first fragment is completed, the apparatus 110 for controlling the fragment may induce the second fragment to be processed through transmitting the second fragment to the apparatus 130 for processing the fragment.

As such, the apparatus 110 for controlling the fragment may control the processing order of the fragment, such that a fragment inputted earlier may be processed first from among fragments occupying the same space on a screen, using the flag data. Transitively, the apparatus 110 for controlling the fragment may prevent an erroneous resulting image from being outputted due to a reversal of the processing order of the fragments occupying the same space on the screen.

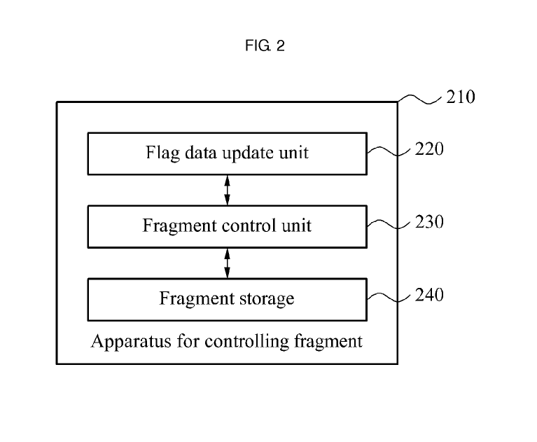

FIG. 2 is a block diagram illustrating a detailed configuration of an apparatus 210 for controlling a fragment, according to example embodiments.

Referring to FIG. 2, the apparatus 210 for controlling the fragment may include a fragment control unit 230 and a flag data update unit 220. Also, in another example embodiment, the apparatus 210 for controlling the fragment may further include a fragment storage 240.

The fragment control unit 230 may generate flag data through monitoring a processing state of a first fragment. The flag data may represent whether the first fragment is currently being processed, and a spatial location of the first fragment in an image frame.

The flag data may be stored in a flag buffer, and the flag buffer may store the flag data corresponding to a plurality of spatial locations in all of the plurality of spatial locations of the image frame. For example, the fragment control unit 230 may additionally assign a predetermined portion of a memory to a portion of a screen area on which fragments are displayed to set the assigned predetermined portion of the memory to be a flag buffer representing a processing state of a fragment. The flag buffer may represent a spatial location of fragments currently being processed by an apparatus (not shown) for processing a fragment, for example, an FS.

The fragment control unit 230 may determine whether to process a second fragment, based on the flag data representing the processing state of the first fragment. As described with respect to FIG. 1, the first fragment and the second fragment may refer to fragments representing an identical spatial location from among fragments included in differing primitives in a frame. The first fragment may refer to a fragment inputted to the apparatus 210 for controlling the fragment prior to the second fragment.

The fragment control unit 230 may determine whether the first fragment is currently being processed in the apparatus for processing the fragment (e.g. an FS) by referencing the flag data when the second fragment is inputted to the apparatus 210 for controlling the fragment.

The fragment control unit 230 may delay the processing of the second fragment until the flag data is updated when the fragment control unit 230 determines that the first fragment is currently being processed through the flag data. Alternatively, in another embodiment, the fragment control unit 230 may control the fragment storage 240 to store the second fragment until the flag data is updated.

For example, when the flag data represents that the first fragment is currently being processed, and the second fragment is inputted to the apparatus 210 for controlling the fragment, the fragment control unit 230 may control transmitting of the second fragment or store the second fragment in the fragment storage 240 temporarily.

The fragment control unit 230 may commence the transmitting of the second fragment or transmit the second fragment stored in the fragment storage 240 to the apparatus for processing the fragment (e.g. an FS) when the flag data is updated and the updated flag data represents that the processing of the first fragment is completed. Transitively, the fragment control unit 230 may prevent fragments occupying the same space on a screen from being processed simultaneously, or from being processed in a reversed processing order.

The fragment control unit 230 may identify a spatial location of the second fragment from location information of the second fragment to read flag data corresponding to the second fragment. For example, the location information of the second fragment may include a pixel coordinate in an image, and a depth value of a pixel, however, the present disclosure is not limited thereto. Subsequently, the fragment control unit 230 may determine whether to process the second fragment through reading the flag data corresponding to the spatial location of the second fragment.

The flag data update unit 220 may monitor a processing state of fragments and update the flag data. The flag data update unit 220 may update the flag data corresponding to a relevant fragment, based on the processing state of the first fragment or the second fragment.

For example, the flag data update unit 220 may represent that the first fragment is currently being processed through updating the flag data corresponding to the spatial location of the first fragment when the processing of the first fragment commences. Subsequently, the flag data update unit 220 may represent that, at present, the processing of the first fragment is completed through updating the flag data when the processing of the first fragment is verified to be completed. The flag data update unit 220 may update the flag data corresponding to the spatial location of the second fragment when the processing of the second fragment commences and is completed.

Depending on embodiments, the fragment storage 240 may store the second fragment until the flag data represents processing of the first fragment is completed through updating the flag data during processing of the first fragment. For example, the fragment storage 240 may store the second fragment until the processing of the first fragment is completed and the flag data is updated when the flag data represents that the first fragment is currently being processed. The fragment storage 240 may transmit the second fragment stored by controlling of the fragment control unit 230 to the apparatus for processing the fragment when the processing of the first fragment is verified to be completed.

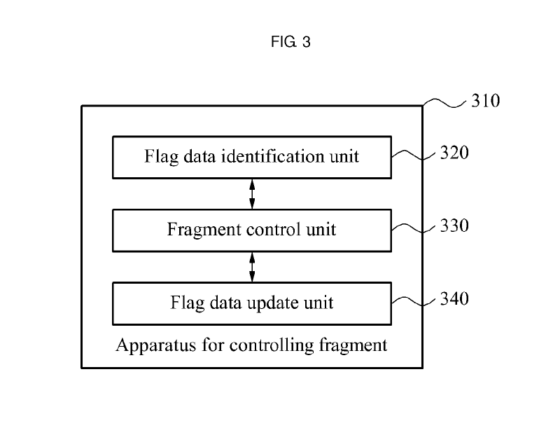

FIG. 3 is a block diagram illustrating a detailed configuration of an apparatus 310 for controlling a fragment, according to other example embodiments.

Referring to FIG. 3, the apparatus 310 for controlling the fragment may include a flag data identification unit 320, a fragment control unit 330, and a flag data update unit 340.

The flag data identification unit 320 may identify flag data corresponding to a second fragment inputted subsequent to a first fragment in order to sequentially process fragments having an identical spatial location in differing image frames. The first fragment and the second fragment may refer to fragments representing the identical spatial location from among fragments included in differing primitives in a frame, however, the first fragment is inputted prior to the second fragment. The flag data identification unit 320 may identify a processing state of the first fragment, based on flag data.

The flag data identification unit 320 may identify the flag data corresponding to the second fragment, based on the spatial location of the second fragment. For example, the flag data identification unit 320 may identify the spatial location of the second fragment in an image frame through analyzing location information of the second fragment, and identify the flag data corresponding to the spatial location of the second fragment. The flag data may represent whether the first fragment is currently being processed and the spatial location of the first fragment in the image frame.

The fragment control unit 330 may determine whether to process the second fragment, based on the flag data. The fragment control unit 330 may determine whether the first fragment is currently being processed in an apparatus (not shown) for processing a fragment through referencing the flag data when the second fragment is inputted to the apparatus 310 for controlling the fragment.

The fragment control unit 330 may delay processing of the second fragment until the flag data is updated to a predetermined value when the first fragment is determined, through the flag data, as currently being processed. Alternatively, in another embodiment, the fragment control unit 330 may store the second fragment in a buffer until the flag data is updated to a predetermined value. The fragment control unit 330 may control the processing of the second fragment to commence when the flag data represents a predetermined value or is updated to a predetermined value that indicates that the processing of the first fragment has completed.

For example, when it is assumed that flag data indicating “1” represents that a fragment corresponding to location information of the flag data is currently being processed, and flag data indicating “0” represents that processing of a relevant fragment is completed, the fragment control unit 330 may delay the processing of the second fragment or store the second fragment in a buffer until the flag data is updated from “1” to “0”. The fragment control unit 330 may transmit the second fragment to the apparatus for processing the fragment to control the processing of the second fragment to commence when the flag data is updated to “0”.

The flag data update unit 340 may update flag data through monitoring a processing state of fragments. For example, the flag data update unit 340 may update the flag data corresponding to a relevant fragment when processing of the first fragment or the second fragment commences or is completed.

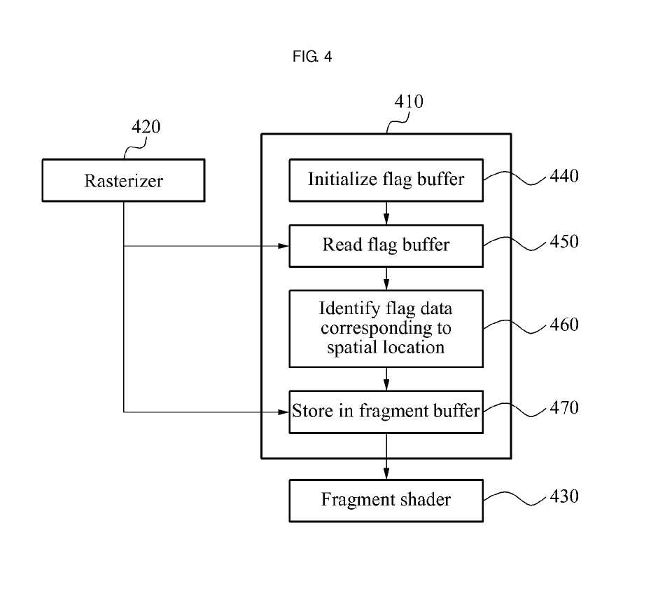

FIG. 4 illustrates a detailed operation performed by an apparatus 410 for controlling a fragment according to example embodiments. More particularly, FIG. 4 illustrates an example of an operation in which the apparatus 410 for controlling the fragment controls a processing order of a fragment between an FS 430 and a rasterizer 420 of an OpenGL.

The apparatus 410 for controlling the fragment may initialize 440 a flag buffer when an operation of controlling a fragment is performed for a first time, or processing of an image frame commences. The flag buffer may store flag data corresponding to a plurality of spatial locations at all of the plurality of spatial locations of an image frame or a screen. The flag buffer may represent a spatial location of fragments being processed by the FS 430.

When a first fragment generated by the rasterizer 420 may be transmitted to the FS 430 through the apparatus 410 for controlling the fragment, and a second fragment generated subsequent to the first fragment is inputted to the apparatus 410 for controlling the fragment, the apparatus 410 for controlling the fragment may read 450 the flag buffer in which the flag data is stored.

Subsequently, the apparatus 410 for controlling the fragment may identify 460 the flag data corresponding to the spatial location of the second fragment in the flag buffer. The apparatus 410 for controlling the fragment may examine a spatial coherence between the second fragment and the flag data, and identify the flag data corresponding to the second fragment.

For example, the apparatus 410 for controlling the fragment may identify the flag data corresponding to the second fragment, based on location information of the second fragment from a plurality of flag data included in the flag buffer. The apparatus 410 for controlling the fragment may analyze the location information of the second fragment, and identify the spatial location of the second fragment in the image frame. Then, the apparatus 410 for controlling the fragment may read the flag data corresponding to the location information of the second fragment.

The apparatus 410 for controlling the fragment may transmit or provide the second fragment to the FS 430 when the identified flag data represents that processing of the first fragment is completed. The FS 430 may perform varied forms of graphics processing through processing the second fragment received.

The apparatus 410 for controlling the fragment may store 470 the second fragment in a fragment buffer when the identified flag data represents that the first fragment is currently being processed. Alternatively, the apparatus 410 for controlling the fragment may transmit (not shown), to the rasterizer 420, a signal for delaying transmission of the second fragment to delay the processing of the second fragment.

In a subsequent step, when the flag data is updated and represents that processing of the first fragment is completed, the apparatus 410 for controlling the fragment may transmit the second fragment stored in the fragment buffer to the FS 430. Alternatively, the apparatus 410 for controlling the fragment may control to transmit (not shown), to the rasterizer 420, a signal for commencing the transmission of the second fragment, and to proceed the processing of the second fragment when the flag data is updated and represents that processing of the first fragment is completed.

The apparatus 410 for controlling the fragment may update the flag data corresponding to the spatial location of the second fragment while transmitting the second fragment to the FS 430 simultaneously.

Through such a process, the apparatus 410 for controlling the fragment may prevent an erroneous resulting image from being outputted due to a reversal of a processing order of fragments having an identical spatial location still belonging to differing primitives present in an identical frame.

In FIG. 4, the example embodiments are not limited to the descriptions in the foregoing although the apparatus 410 for controlling the fragment is described to be disposed between the rasterizer 420 and the FS 430. The apparatus 410 for controlling the fragment may be disposed at any step at which a processing order of a fragment may be reversed during a graphic rendering process so as to control the processing order of the fragment.

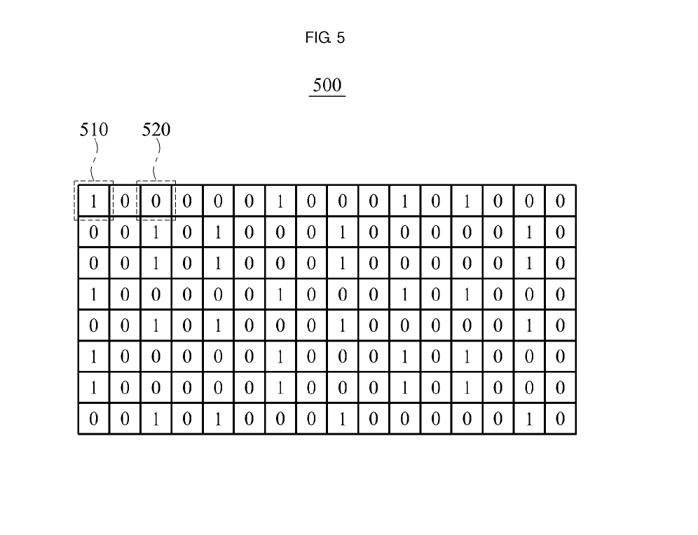

FIG. 5 illustrates an example of a flag buffer 500 in which flag data is stored, according to example embodiments.

Referring to FIG. 5, the flag buffer 500 may store a plurality of flag data. The flag buffer 500 may store flag data corresponding to a plurality of spatial locations in all of the plurality of spatial locations of an image frame. A location in the flag buffer 500 at which the plurality of flag data is present may correspond to the plurality of spatial locations of fragments in an image frame.

In FIG. 5, during processing of a first fragment, flag data may indicate “1”, and when processing of the first fragment is completed, flag data may indicate “0”, however, the present disclosure is not limited thereto.

When the flag data indicates “1” 510, an apparatus for controlling a fragment may identify that the first fragment having a spatial location corresponding to relevant flag data is currently being processed. The apparatus for controlling the fragment may delay processing of a second fragment, based on the flag data when the second fragment is inputted subsequent to the first fragment to be inputted. The apparatus for controlling the fragment may delay the processing of the second fragment until the flag data of 510 is updated from “1” to “0”.

In another case, when the flag data indicates “0” 520, the apparatus for controlling the fragment may identify that the processing of the first fragment having a spatial location corresponding to relevant flag data is currently completed. Accordingly, the apparatus for controlling the fragment may induce the second fragment to be processed through transmitting the inputted second fragment to the apparatus for processing the fragment. Also, the apparatus for controlling the fragment may update the flag data corresponding to the spatial location of the second fragment while inducing the second fragment to be processed simultaneously.

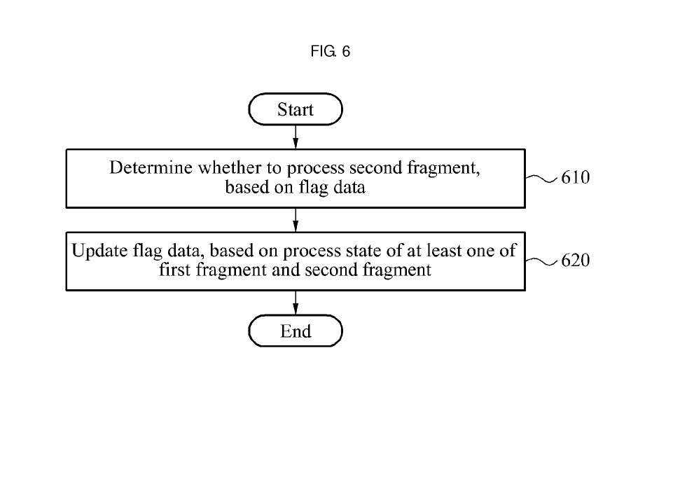

FIG. 6 is a flowchart illustrating an operation of a method of controlling a fragment, according to example embodiments.

In operation 610, an apparatus for controlling a fragment may determine whether to process a second fragment, based on flag data representing a processing state of a first fragment. The flag data may represent whether the first fragment is currently being processed and a spatial location of the first fragment in an image frame. For example, the flag data may be stored in a flag buffer, and the flag buffer may store the flag data corresponding to a plurality of spatial locations in all of the plurality of spatial locations in an image frame.

The apparatus for controlling the fragment may determine whether the first fragment is currently being processed through referencing the flag data when the second fragment is inputted. The apparatus for controlling the fragment may delay processing of the second fragment until the flag data is updated when the apparatus for controlling the fragment determines, through the flag data, that the first fragment is currently being processed. Alternatively, the apparatus for controlling the fragment may temporarily store the second fragment until the flag data is updated.

The apparatus for controlling the fragment may identify a spatial location of the second fragment from location information of the second fragment in order to read the flag data corresponding to the second fragment. Subsequently, the apparatus for controlling the fragment may determine whether to process the second fragment through reading the flag data corresponding to the spatial location of the second fragment.

In operation 620, the apparatus for controlling the fragment may update the flag data through monitoring a processing state of fragments. The apparatus for controlling the fragment may update the flag data corresponding to a relevant fragment, based on the processing state of the first fragment or the second fragment. The apparatus for controlling the fragment may update the flag data corresponding to the spatial location of a relevant fragment when the processing of the first fragment or the second fragment commences or is completed.

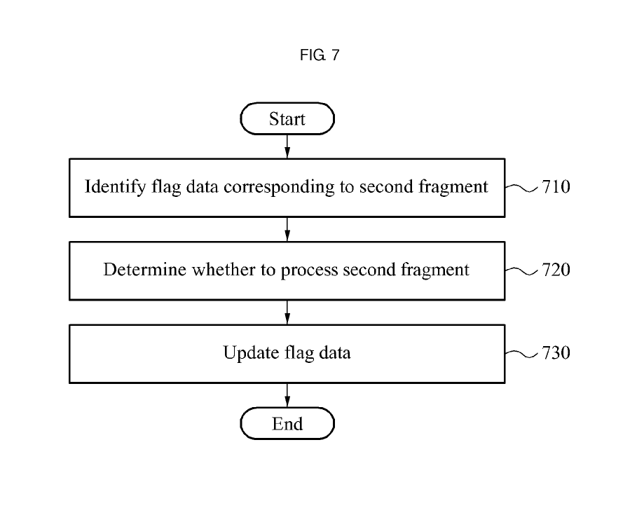

FIG. 7 is a flowchart illustrating an operation of a method of controlling a fragment, according to other example embodiments.

In operation 710, an apparatus for controlling a fragment may identify flag data corresponding to a second fragment inputted subsequent to a first fragment in order to sequentially process fragments representing an identical spatial location among fragments included in differing primitives in a frame. The first fragment and the second fragment may occupy the same space on a screen. The apparatus for controlling the fragment may identify a processing state of the first fragment, based on the flag data.

The apparatus for controlling the fragment may identify the flag data corresponding to the second fragment, based on a spatial location of the second fragment. The apparatus for controlling the fragment may identify the spatial location of the second fragment in an image frame through analyzing location information of the second fragment, and identify the flag data corresponding to the spatial location of the second fragment.

In operation 720, the apparatus for controlling the fragment may determine whether to process the second fragment, based on the flag data. The apparatus for controlling the fragment may determine whether the first fragment is currently being processed through referencing the flag data when the second fragment is inputted.

The apparatus for controlling the fragment may delay processing of the second fragment until the flag data is updated to a predetermined value when the apparatus for controlling the fragment determines, through the flag data, that the first fragment is currently being processed. Alternatively, the apparatus for controlling the fragment may store the second fragment in a buffer until the flag data is updated to a predetermined value that indicates that the processing of the first fragment is completed. The apparatus for controlling the fragment may control the processing of the second fragment to commence when the flag data represents a predetermined value or is updated to a predetermined value.

In operation 730, the apparatus for controlling the fragment may update flag data through monitoring a processing state of fragments. The apparatus for controlling the fragment may update flag data corresponding to a relevant fragment when the processing of the first fragment or the second fragment commences or is completed.

A portable device as used throughout the present specification includes mobile communication devices, such as a personal digital cellular (PDC) phone, a personal communication service (PCS) phone, a personal handy-phone system (PHS) phone, a Code Division Multiple Access (CDMA)-2000 (1X, 3X) phone, a Wideband CDMA phone, a dual band/dual mode phone, a Global System for Mobile Communications (GSM) phone, a mobile broadband system (MBS) phone, a satellite/terrestrial Digital Multimedia Broadcasting (DMB) phone, a Smart phone, a cellular phone, a personal digital assistant (PDA), an MP3 player, a portable media player (PMP), an automotive navigation system (for example, a global positioning system), and the like. Also, the portable device as used throughout the present specification includes a digital camera, a plasma display panel, and the like.

The method of controlling the fragment according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Further, according to an aspect of the embodiments, any combinations of the described features, functions and/or operations can be provided.

Moreover, the apparatuses discussed above may include at least one processor to execute at least one of the above-described units and methods.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A method of controlling a fragment, the method comprising:
determining whether to process a second fragment based on flag data representing a processing state of a first fragment; and
updating the flag data based on a processing state of at least one of the first fragment and the second fragment.

2. The method of claim 1, wherein the first fragment and the second fragment correspond to fragments representing an identical spatial location from among fragments included in differing primitives in a frame.

3. The method of claim 1, wherein the determining comprises at least one of:
delaying processing of the second fragment until the flag data represents that processing of the first fragment is completed; and
storing the second fragment in a buffer until the flag data represents that processing of the first fragment is completed.

4. The method of claim 1, wherein the determining comprises:
identifying a spatial location of the second fragment from location information of the second fragment; and
determining whether to process the second fragment based on flag data corresponding to the spatial location of the second fragment.

5. The method of claim 1, wherein the updating comprises:
updating flag data corresponding to a spatial location of the second fragment when processing of the second fragment commences.

6. The method of claim 1, wherein the updating comprises:
updating flag data corresponding to a spatial location of the second fragment when processing of the second fragment is completed.

7. The method of claim 1, wherein the flag data represents whether the first fragment is currently being processed, and a spatial location of the first fragment in an image frame.

8. A method of controlling a fragment, the method comprising:
identifying flag data corresponding to a second fragment inputted subsequent to a first fragment in order to process fragments having an identical spatial location in differing image frames; and
determining whether to process the second fragment based on the flag data.

9. The method of claim 8, wherein the fragments having an identical spatial location are processed in a sequential manner.

10. The method of claim 8, wherein the identifying comprises:
identifying the flag data corresponding to the second fragment, based on the spatial location of the second fragment.

11. The method of claim 8, wherein the determining comprises at least one of:
delaying processing of the second fragment until the flag data is updated to a predetermined value; and.
storing the second fragment in a buffer until the flag data is updated to a predetermined value.

12. The method of claim 8, wherein the determining comprises:
controlling processing of the second fragment to commence when the flag data represents a predetermined value or is updated to a predetermined value.

13. The method of claim 8, further comprising:
updating the flag data when processing of at least one of the first fragment and the second fragment commences or is completed.

14. A non-transitory computer-readable medium comprising a program for instructing a computer to perform the method of claim 1.

15. An apparatus for controlling a fragment, the apparatus comprising:
a fragment control unit to determine whether to process a second fragment, based on flag data representing a processing state of a first fragment; and
a flag data update unit to update the flag data, based on a processing state of the second fragment.

16. The apparatus of claim 15, wherein the first fragment and the second fragment correspond to fragments representing an identical spatial location among fragments included in differing primitives in a frame.

17. The apparatus of claim 15, wherein the fragment control unit delays processing of the second fragment until the flag data is updated during processing of the first fragment.

18. The apparatus of claim 15, further comprising:
a fragment storage to store the second fragment until the flag data is updated during processing of the first fragment.

19. The apparatus of claim 15, wherein the flag data update unit updates flag data corresponding to the second fragment when the processing of the second fragment commences or is completed.

20. The apparatus of claim 15, wherein the fragment control unit assigns a predetermined portion of a memory to a portion of a screen area on which fragments are displayed to set the assigned predetermined portion of the memory to be a flag buffer representing a processing state of a fragment.
